(19) United States
(12) Patent Application Publication
(10) Pub. No.: US 2007/0244982 A1
(43) Pub. Date: Oct. 18, 2007

(54) Hybrid Unicast and Multicast Data Delivery

(76) Inventors: Samuel Thomas Scott, III, Los Gatos, CA (US); Kevin T. Carle, Mountain View, CA (US)

Correspondence Address: LEE & HAYES PLLC, 421 W RIVERSIDE AVENUE SUITE 500, SPOKANE, WA, 99201, US

(21) Appl. No.: 11/379,042

(22) Filed: Apr. 17, 2006

(51) Int. Cl. G06F 15/16

(52) U.S. Cl. 709/217

(57) ABSTRACT

Hybrid unicast and multicast data delivery involves delivering data to client devices partially using a unicast communication and partially using a multicast communication. For example, higher-relevancy television metadata may be extracted from television metadata. A server transmits the higher-relevancy television metadata to a client via a unicast communication burst. The client can otherwise receive the television metadata from the server via a multicast communication stream.

### BACKGROUND

An increasing percentage of people receive television channels through cable or satellite television providers. Both cable and satellite television providers currently have the capacity to deliver dozens, if not hundreds, of television channels. With so many channels, subscribers have difficulty knowing what programs are currently available. It is even more difficult for subscribers to know what programs will be shown on the multitude of channels in the future.

To help subscribers know what programs can be viewed, at which times, and on what channels, cable and satellite television providers usually offer an electronic program guide (EPG). An EPG is typically a comprehensive and interactive application that provides a television schedule to a subscriber. For example, EPGs indicate what program is being shown on each channel during each program time slot. EPGs also often describe and/or provide a synopsis of each scheduled television program.

### SUMMARY

Hybrid unicast and multicast data delivery involves delivering data to client devices partially using a unicast communication and partially using a multicast communication. For example, higher-relevancy television metadata may be extracted from television metadata. A server transmits the higher-relevancy television metadata to a client via a unicast communication burst. The client can otherwise receive the television metadata from the server via a multicast communication stream.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Moreover, other method, system, scheme, apparatus, device, media, procedure, API, arrangement, etc. implementations are described herein.

### BRIEF DESCRIPTION OF THE DRAWINGS

The same numbers are used throughout the drawings to reference like and/or corresponding aspects, features, and components.

FIG. 1 is a block diagram of an example television environment having a client and a server in which hybrid unicast and multicast data delivery may be implemented.

FIG. 2 is a block diagram illustrating an example service information segmentation and an example electronic program guide (EPG) segmentation that may be performed in conjunction with hybrid unicast and multicast data delivery.

FIG. 3 is a block diagram of an example server that implements hybrid unicast and multicast data delivery for television metadata.

FIG. 4 is a flow diagram that illustrates an example method between a client and a server for hybrid unicast and multicast data delivery.

FIG. 5 is a continuation of the flow diagram of FIG. 4 that illustrates the example method between a client and a server for hybrid unicast and multicast data delivery.

FIG. 6 is a block diagram of an example device that may be employed in conjunction with hybrid unicast and multicast data delivery.

### DETAILED DESCRIPTION

### Introduction

As described above, the breadth and depth of television channel offerings in typical cable and satellite systems is quite large. In fact, navigating through the available channels can be a daunting, unsatisfying challenge for subscribers without the benefit of an electronic program guide (EPG). To operate an EPG at a client device, the client device has access to appropriately-current EPG data. This EPG data is delivered to the client device from a server.

Usually, EPG data is delivered from the server to the client device on an ongoing basis using what is termed a repeating carousel of EPG data. The repeating carousel of EPG data is delivered frequently enough and fast enough, as well as far enough ahead in time, that subscribers can utilize the EPG application at their convenience and without significant latency.

However, this is typically not true when a client device is initially powered on (e.g., when turned on for the first time, when turned on after a power outage or disconnection, etc.) or recently connected or reconnected to the EPG data source. In situations in which the client device does not have current EPG data, the subscriber may be waiting for some time before the EPG application can be used effectively.

The server may be capable of bursting the EPG data to the client device relatively quickly. Unfortunately, this consumes too much bandwidth when the multitude of client devices within a given network is considered. In other words, the repeating carousel of EPG data can deliver the EPG data too slowly, and the bursting of the EPG data to an individual client device can be an inefficient use of network bandwidth.

In contrast, with an implementation as described herein, hybrid unicast and multicast data delivery is employed to balance network bandwidth usage versus the delay experienced by subscribing users. When a client device discovers that it needs EPG data for its EPG application, the client device requests higher-relevancy EPG data from the server. In response, the higher-relevancy EPG data is transmitted from the server to the client device in a unicast burst. The higher-relevancy EPG data may be, for example, EPG data for a relatively near-term set of television program time slots. This enables the subscriber to view near-term (including current) EPG data with possibly little, if any, noticeable delay.

Meanwhile, the server is continuing to transmit the repeating carousel of EPG data to the client device as part of a multicast communication. The client device can gradually blend the higher-relevancy EPG data with the EPG data being received in the repeating carousel via the multicast communication. The server may be continuously creating the higher-relevancy EPG data based on a predetermined higher-relevancy EPG time period or may create the higher-relevancy EPG data responsive to each request. This segmentation of television data may also be applied to other television metadata types, such as service information (SI), user preferences, and so forth.

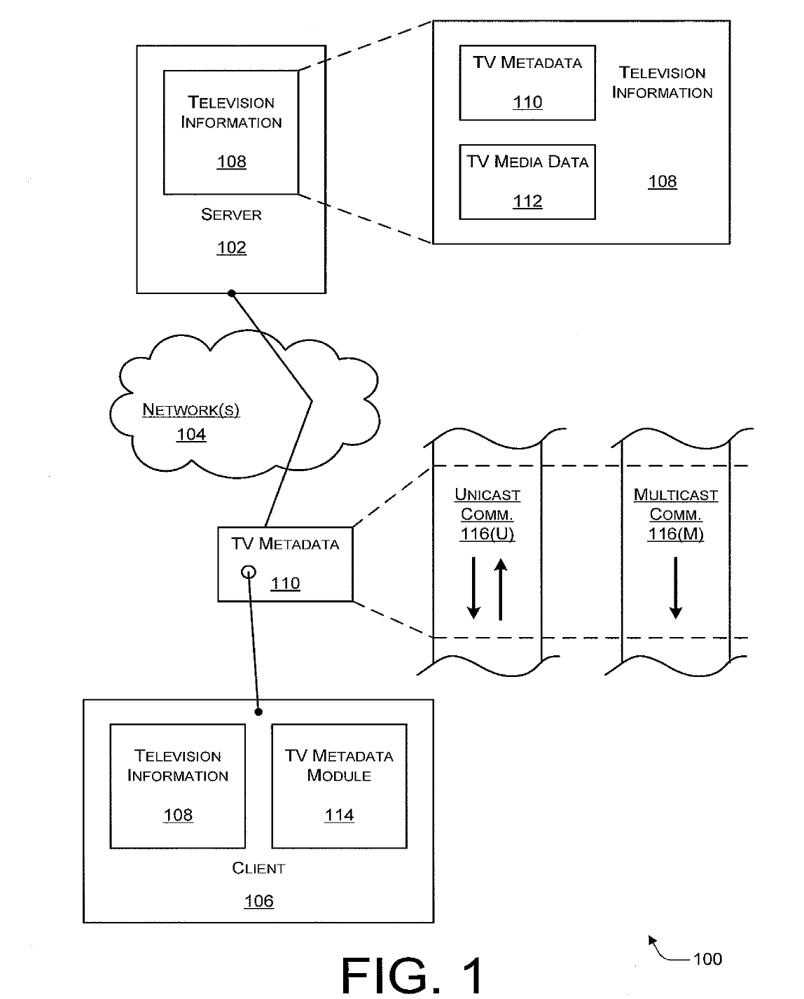

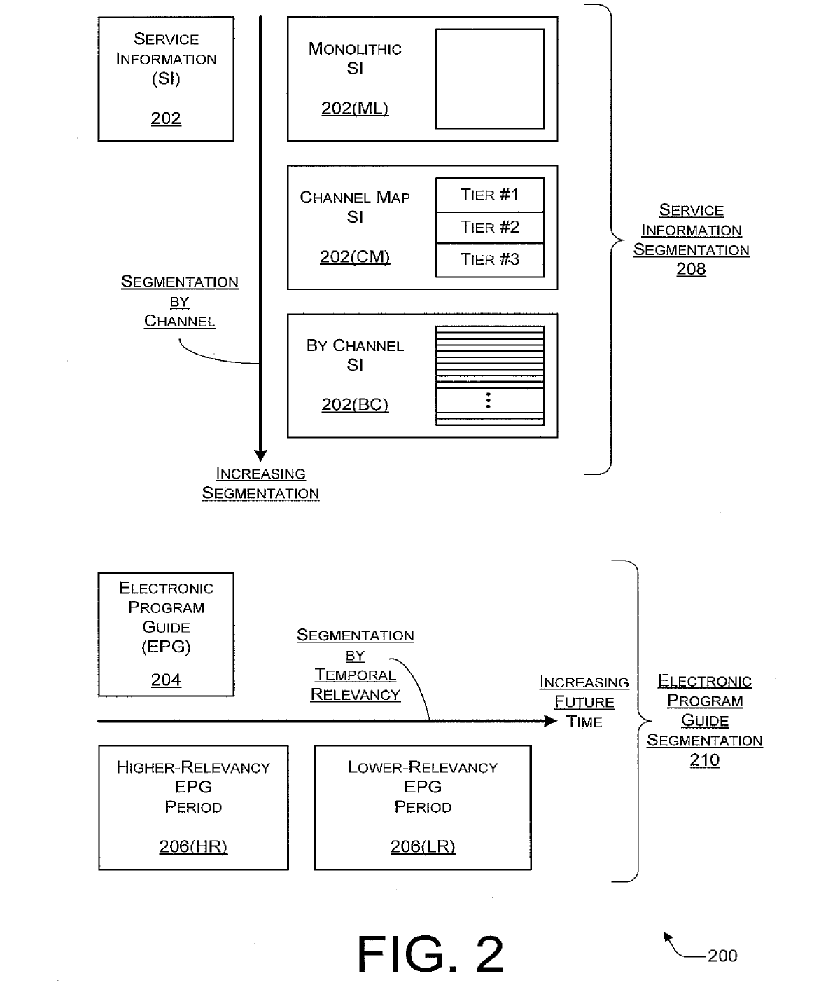

The remainder of the “Detailed Description” is divided into three sections. A first section is entitled “Example Environments for Hybrid Unicast and Multicast Data Delivery” and references FIG. 1. A second section is entitled “Example Implementations for Hybrid Unicast and Multicast Data Delivery” and references FIGS. 2-5. A third section references FIG. 8 and is entitled “Example Device Implementations for Hybrid Unicast and Multicast Data Delivery”.

### Example Environments for Hybrid Unicast and Multicast Data Delivery

FIG. 1 is a block diagram of an example television environment 100 having a client 106 and a server 102 in which hybrid unicast and multicast data delivery may be implemented. As illustrated, television environment 100 includes server 102, one or more networks 104, and client 106. Server 102 includes television information 108. Television information 108 includes television (TV) metadata 110 and TV media data 112. Client 106 includes television information 108 and a TV metadata module 114.

In a described implementation, server 102 provides television information 108 to client 106 via one or more networks 104. Network 104 may be a cable network, a telephone network, an internet, an intranet, a satellite network, a wired network, a wireless, network, a fiber optic network, a digital subscriber line (DSL) network, some combination thereof, and so forth. Although only a single client 106 is shown, each server 102 typically services many such clients 106.

Server 102 may be realized with one or more server hardware components. In an example implementation, server 102 comprises at least part of a head-end of a satellite and/or cable television service provider. However, server 102 may instead be a web server on the internet, a wireless access point server in a wireless wide area network (WAN), or some other type of server. Regardless, server 102 has access to television information 108, and server 102 is capable of providing television information 108 to one or more clients 106.

In a described implementation, television information 108 includes TV metadata 110 and TV media data 112. TV media data 112 is the image, audio, visual, audio/visual, etc. data that is used by client 106 to present a television channel to a subscriber. The television channel presentation may include displaying video on a display screen and playing audio on speakers. TV metadata 110 is ancillary data that is used to provide other features or services beyond the presentation of an individual television channel. EPG data is an example of TV metadata 110. Other examples are described herein below.

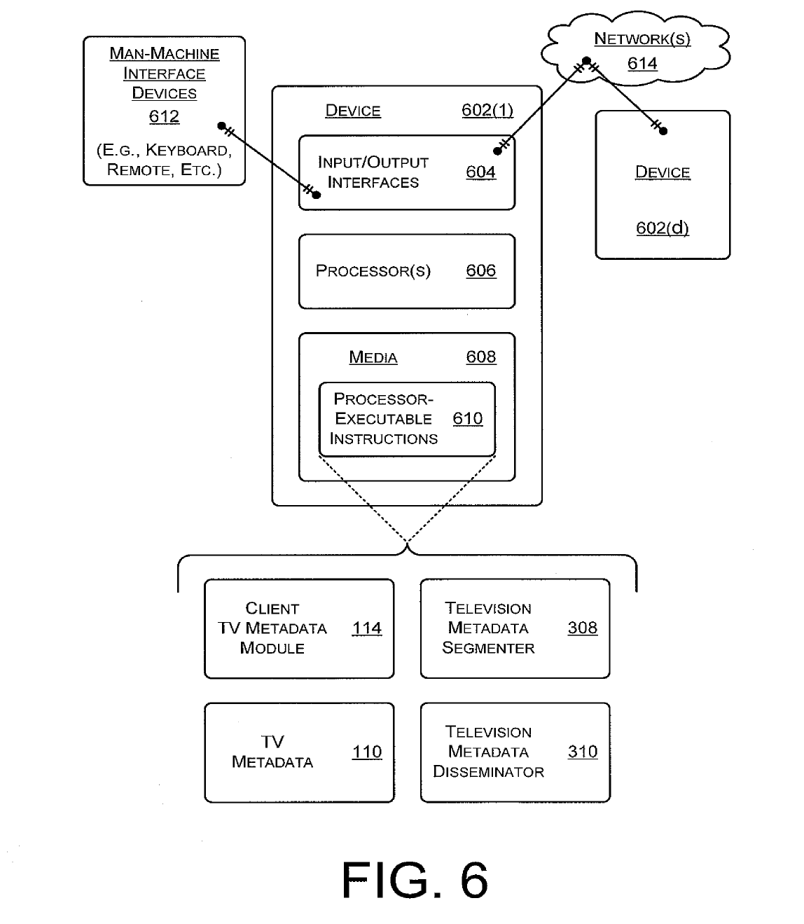

Client 106 may be any general client device. Example client devices include, but are not limited to, a television, a television set-top box, a video-capable computer, a video-capable portable device (e.g., a mobile phone, a personal digital assistant (PDA), and/or a wireless email device, etc.), some combination thereof and so forth. An example of a general device that may implement a server 102 or a client 106 is described herein below with particular reference to FIG. 6.

In a described implementation, client 106 includes television information 108 and a TV metadata module 114. At client 106, television information 108 includes at least part of the TV metadata 110 that is accessible to server 102. At client 106, television information 108 includes (on at least a transient basis) at least part of the TV media data 112 that is transmitted from server 102. TV metadata module 114 is capable of processing TV media data 112. For example, TV metadata module 114 includes an EPG application that processes EPG data and presents an EPG user interface (UI). Although not explicitly shown, client 106 also includes a TV media data module that processes TV media data 112 for presentation by client 106.

As illustrated, server 102 communicates TV metadata 110 to client 106 via network 104. In a described implementation, TV metadata 110 is being transmitted to client 106, as well as to other client devices, as a repeating carousel of TV metadata in a multicast communication 116(M). Although clients may send join requests or similar multicast-oriented communications to server 102, multicast communication 116(M) is primarily a one-way communication. The one-way nature of multicast communication 116(M) is indicated by the single arrow pointing from server 102 toward client 106.

At least a portion of TV metadata 110 is also transmitted to client 106 in a unicast communication 116(U). As indicated by the double arrows, unicast communication 116(U) is more of a two-way communication. When client 106 discovers that TV metadata 110 is desired, client 106 requests delivery of TV metadata 110. In response to receiving the request, server 102 sends at least a portion of TV metadata 110 to client 106 in a unicast communication 116(U) burst.

In a described implementation, the portion of TV metadata 110 that is transmitted in unicast communication 116(U) comprises higher-relevancy TV metadata. Examples of higher-relevancy TV metadata include TV metadata that is necessary (if any is necessary) for presenting TV media data 112, relatively near-term EPG data, and so forth.

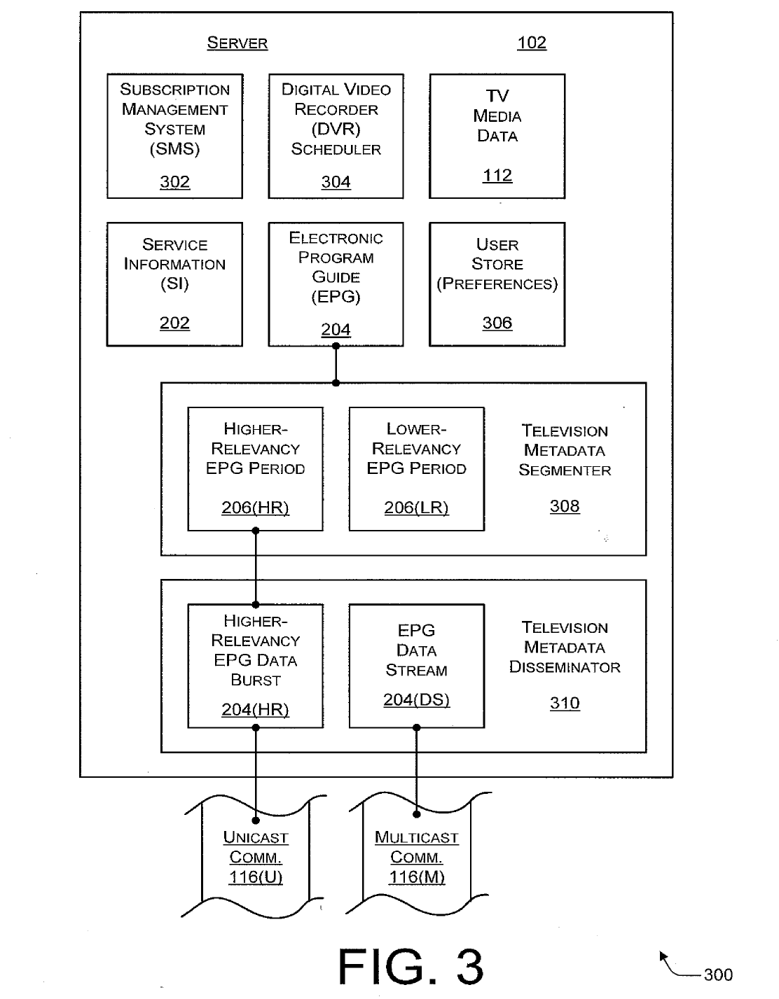

Generally, TV metadata 110 may include service information (SI), EPG data, subscription management system (SMS) information, digital video recorder (DVR) scheduler information, user store information, and so forth. These examples of TV metadata 110 are described herein below with particular reference to FIG. 3. SI and EPG data are also described herein below with particular reference to FIG. 2, especially in the context of TV metadata segmentation.

Multicast communication 116(M) and unicast communication 116(U) may be sent over the same network using the same communication channel. For example, both multicast and unicast communications 116(M) and 116(U) may be transmitted over a cable network from an operator's head-end. However, the communication channel for multicast communication 116(M) may differ from the communication channel for unicast communication 116(U). For example, unicast communication 116(U) may be transmitted over a wired communication channel, such as coaxial cable, a fiber optic cable, “traditional” twisted pair telephone wires, etc. while multicast communication 116(M) is transmitted over a different wired communication channel, such as a satellite broadcast, a terrestrial wireless broadcast, and so forth.

### Example Implementations for Hybrid Unicast and Multicast Data Delivery

FIG. 2 is a block diagram 200 illustrating an example service information segmentation 208 and an example electronic program guide segmentation 210 that may be performed in conjunction with hybrid unicast and multicast data delivery. Service information segmentation 208 illustrates example segmentations by channel. EPG segmentation 210 illustrates an example segmentation by time.

Service information (SI) 202 generally indicates what services are available and includes a description of each service. More specifically, SI 202 includes tuning information. Tuning information may be, for example, data about what media streams (e.g., television channels) are available, how the available media streams may be accessed, the bit rates of the available media streams, and so forth. The media streams may be accessed by network location. Network locations include, but are not limited to, a network address, a multicast address, a tuning frequency, an identification code, some combination thereof, and so forth.

Service information segmentation 208 illustrates example segmentations by channel. The arrow indicates increasing segmentation. Monolithic SI 202(ML) is actually the absence of segmentation in which SI 202 is transmitted as a single monolithic unit. Channel map SI 202(CM) is SI 202 segmented into different channel maps. As illustrated, there are three channel maps: tier #1, tier #2, and tier #3 (e.g., silver, gold, and platinum television channel packages). Channel map SI 202(CM) may alternatively be segmented into fewer or more than three different tiers.

By channel SI 202(BC) is SI 202 segmented into each individual available channel. If there are “x” different total television channels, then SI 202 is segmented into “x” portions for by the channel SI 202(BC). Although three different channel segmentation options are shown, other SI channel segmentation approaches may alternatively be implemented. Moreover, SI 202 may also be segmented in other (non-channel) manners.

Segmentation enables less than all of SI 202 to be included in the unicast communication 116(U) (of FIG. 1) that is transmitted to client 106. For example, a subscriber that subscribes to a second tier television package may be sent the segmented portion of channel map SI 202(CM) that sufficiently describes those channels corresponding to tier #2. Omitting parts of channel map SI 202(CM) that describe channels that are not available to the subscriber of client 106 reduces the amount of data included in unicast communication 116(U).

EPG segmentation 210 illustrates an example segmentation by time. More specifically, EPG segmentation 210 illustrates an example segmentation by temporal relevancy. The arrow indicates increasing future time.

EPG 204 includes the data used by an EPG application (of TV metadata module 114) to create an EPG UI for a subscriber at client 106. The EPG data may include, for example, television program titles, descriptions, presentation times, ratings, and/or involved artists, and so forth.

EPG segmentation 210 includes a higher-relevancy EPG period 206(HR) and a lower-relevancy EPG period 206(LR). Subscribers are usually more interested in programs that are being presented in the relatively near-term. Consequently, they are typically more likely to want to peruse the portion of EPG 204 that corresponds to higher-relevancy EPG period 206(HR). Accordingly, the portion of EPG 204 that corresponds to higher-relevancy EPG period 206(HR) may be extracted and sent as part of unicast communication 116(U). Subscribers can therefore relatively quickly access the portion of EPG 204 that is most likely to interest them.

SI 202 and EPG 204 may be segmented differently from the examples illustrated in FIG. 2. For example, SI 202 may be segmented based on a user's previously-monitored viewing habits. Also, EPG 204 may be segmented by channel instead of or in addition to the illustrated temporal relevancy segmentation. For instance, a subscriber that subscribes to tier #1 may be sent the portion of EPG 204 that includes the television channels of tier #1 (and omits those exclusive to tiers #2 and #3) and that corresponds to higher-relevancy EPG period 206(HR).

FIG. 3 is a block diagram of an example server 102 that implements hybrid unicast and multicast data delivery for television metadata. As illustrated, server 102 includes (e.g., stores or otherwise has access to) TV media data 112. Server 102 also includes specific examples of TV metadata 110 (of FIG. 1). These TV metadata 110 examples include: SI 202 (of FIG. 2, too), EPG 204, subscription management system (SMS) information 302, digital video recorder (DVR) scheduler information 304, and user store preferences 306.

As described herein above, EPG 204 includes EPG data for an EPG application. SI 202 includes basic tuning information that describes stream attributes. Stream attributes can be, for example, an internet protocol (IP) address, a bit rate, a service content description, and so forth. A service content description is the overall organization of a television channel (e.g., the video, still images of logos, barker channels, secondary channels, etc.).

SMS information 302 includes access rights to channels per device and/or per its associated subscriber/subscription. DVR scheduler information 304 includes scheduling information for DVR services. User store 306 includes preferences per user. For example, it may include per-channel black-out or lock-out instructions. User store preferences 306 may be included as higher-relevancy TV metadata as part of a unicast communication 116(U).

In a described implementation, server 102 includes a television metadata segmenter 308 and a television metadata disseminator 310. Television metadata segmenter 308 is capable of segmenting TV metadata 110 into higher-relevancy TV metadata and lower-relevancy TV metadata. The higher-relevancy TV metadata is designated for transmission in a burst via unicast communication 116(U). Typically, the entirety of current TV metadata 110 is designated for repeated carousel-style transmission via multicast communication 116(M). However, less than the entirety may alternatively be transmitted via multicast communication 116(M).

In a described implementation, SI 202 is segmented into higher-relevancy versus lower relevancy based on channels and/or channel packages. EPG 204 is segmented into higher-relevancy versus lower-relevancy based on temporal relevancy. In other words, EPG data for near-term programs are considered more relevant than EPG data for programs being presented further into the future. Thus, television metadata segmenter 308 extracts higher-relevancy EPG data 204(HR) from EPG 204.

Television metadata disseminator 310 is capable of transmitting TV metadata 110 differently depending on its relevancy. Higher-relevancy TV metadata is transmitted via a unicast communication 116(U). Lower-relevancy TV metadata is transmitted via a multicast communication 116(M). More specifically, higher-relevancy TV metadata is transmitted in respective unicast bursts to respective individual clients responsive to receipt of respective requests from the respective individual clients. Lower-relevancy TV metadata is transmitted to multiple clients in a multicast stream in a repeating carousel of TV metadata.

Although television metadata segmenter 308 and television metadata disseminator 310 apply to TV metadata 110 generally, they are illustrated in FIG. 3 and described below specifically with respect to the EPG data 204 type of TV metadata 110. Hence, television metadata segmenter 308 employs higher-relevancy EPG period 206(HR) and lower-relevancy EPG period 206(LR) to segment EPG 204. Specifically, television metadata segmenter 308 produces higher-relevancy EPG data 204(HR) that is the portion of EPG data 204 that corresponds to higher-relevancy EPG period 206(HR). Higher-relevancy EPG data 204(11R) is forwarded from television metadata segmenter 308 to television metadata disseminator 310.

Television metadata disseminator 310 formulates higher-relevancy EPG data burst 204(HR) from the higher-relevancy EPG data received from television metadata segmenter 308. Higher-relevancy EPG data burst 204(HR) is sent to a requesting client in a unicast communication 116(U). Television metadata disseminator 310 also formulates EPG data stream 204(DS) from all or a portion of EPG 204. EPG data stream 204(DS) is sent to multiple clients in a multicast communication 116(M). These multiple clients include the requesting client that receives higher-relevancy EPG data burst 204(11R) via unicast communication 116(U).

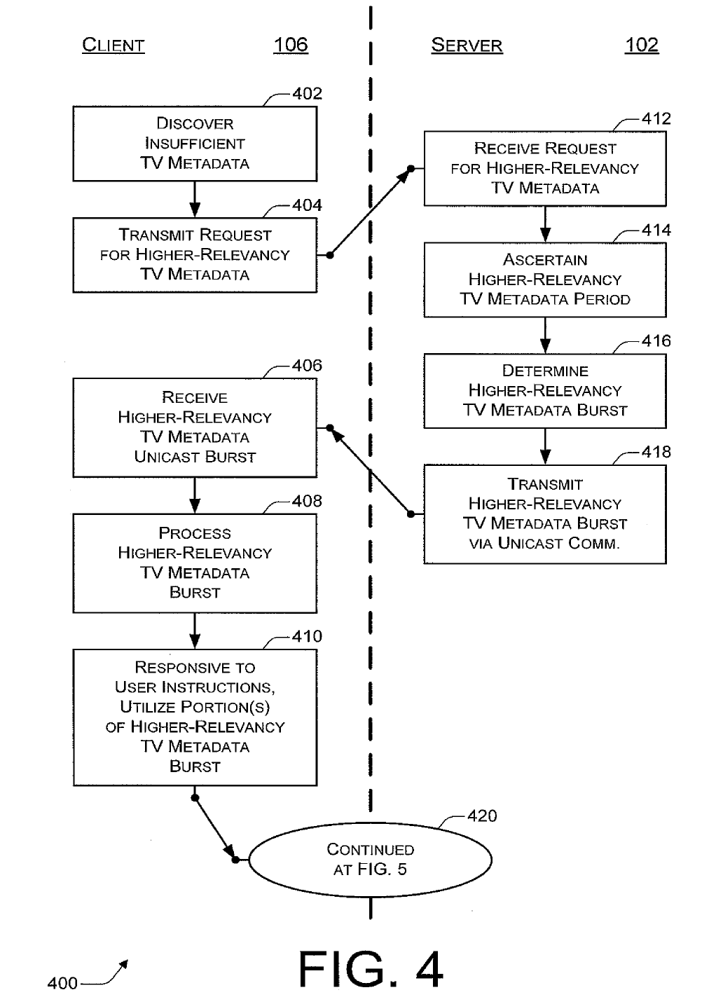

FIG. 4 is a flow diagram 400 that illustrates an example method between a client and a server for hybrid unicast and multicast data delivery. Flow diagram 400 includes nine (9) blocks 402-418. Although the actions of flow diagram 400 may be performed in other environments and with a variety of hardware and software combinations, a TV metadata module 114 of a client 106 that is in communication with a server 102 over a network 104 may be used to implement the method of flow diagram 400. For example, client 106 may perform the actions of blocks 402-404 and 406-410, and server 102 may perform the actions of blocks 412-418.

At block 402, the client device discovers that it has insufficient TV metadata. For example, client 106 may be starting from a reboot or a cold-boot power-on condition. At block 404, the client transmits a request for higher-relevancy TV metadata to the server. The request may be transmitted over network 104 and may optionally include a specified higher-relevancy TV metadata period.

At block 412, the server receives the request for the higher-relevancy TV metadata from the client. At block 414, a higher-relevancy TV metadata period is ascertained. For example, the server may extract the specified higher-relevancy TV metadata period (if present) from the request. Alternatively, the server may utilize a predetermined higher-relevancy TV metadata period that is not responsive to the request of the client. The predetermined higher-relevancy TV metadata period may be the same for all clients, may be different for individual clients (e.g., subscribers on certain channel packages may be granted a longer higher-relevancy TV metadata period), and so forth.

At block 416, a higher-relevancy TV metadata burst is determined by the server. For example, the server may determine a higher-relevancy TV metadata burst based on the ascertained higher-relevancy TV metadata period. For instance, a portion of EPG 204 that corresponds to the ascertained higher-relevancy TV metadata period may be segmented or extracted from EPG 204 by television metadata segmenter 308 to produce a higher-relevancy EPG data burst 204(HR). Similarly, a portion of SI 202 that is ascertained to be of a higher-relevancy may be segmented or extracted from SI 202 by television metadata segmenter 308 to produce a higher-relevancy SI burst. The different types of higher-relevancy TV metadata bursts may be combined into a single higher-relevancy TV metadata burst unit. The higher-relevancy TV metadata burst may be determined by the server in response to each request or independently and repeatedly on an ongoing basis as time transpires.

At block 418, the higher-relevancy TV metadata burst is transmitted via a unicast communication to the requesting client. For example, a higher-relevancy EPG data burst 204(HR) (and possibly other types of higher-relevancy TV metadata) may be transmitted using television metadata disseminator 310 from server 102 to client 106 over network 104 via a unicast communication 116(U).

At block 406, the higher-relevancy TV metadata unicast burst is received at the client. For example, higher-relevancy EPG data burst 204(HR) (and possibly other types of higher-relevancy TV metadata) may be received from server 102 at client 106 via unicast communication 116(U). At block 408, the client processes the higher-relevancy TV metadata burst. For example, TV metadata module 114 may process higher-relevancy EPG data burst 204(HR) to prepare it for display in an EPG.

At block 410, responsive to user instructions, the client utilizes (e.g., displays, interprets for tuning, etc.) portion(s) of the higher-relevancy TV metadata received in the unicast burst communication. For example, TV metadata module 114 may display portions of higher-relevancy EPG data burst 204(HR) responsive to user instructions to the client 106 to display the programs scheduled on certain television channels at particular program time slots. Program time slots may be as short as, for example, a minimum temporal granularity (e.g., one minute, five minutes, 30 minutes, etc.) of the EPG or extend indefinitely, depending on television channel and/or program. Also, TV metadata module 114 may, for example, utilize portions of received higher-relevancy SI 202 to tune to a selected channel.

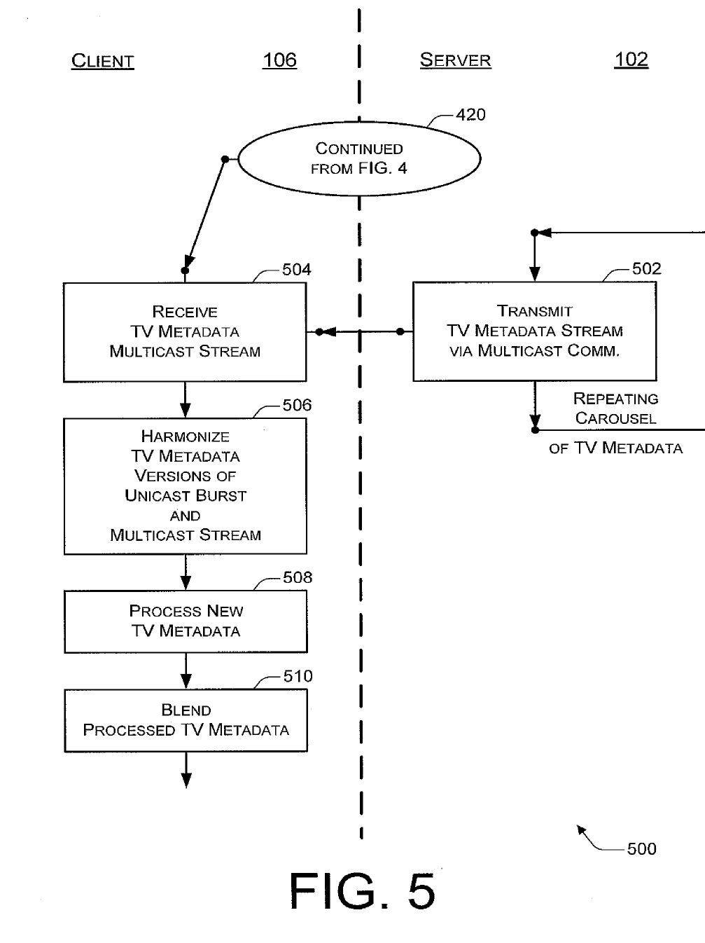

As indicated at the elliptical block 420, the method illustrated by the flow diagram 400 continues at FIG. 5. Specifically, the relationship between, and the handling of, higher-relevancy TV metadata received via a unicast communication 116(U) and the other TV metadata received on a repeating carousel via a multicast communication 116(M) is shown in FIG. 5.

FIG. 5 is a continuation flow diagram 500 of flow diagram 400 (from FIG. 4) that illustrates the example method between a client and a server for hybrid unicast and multicast data delivery. Flow diagram 500 includes five (5) blocks 502-510. As noted above, although the actions of flow diagram 500 may be performed in other environments and with a variety of hardware and software combinations, a TV metadata module 114 of a client 106 that is in communication with a server 102 over a network 104 may be used to implement the method of flow diagram 500. For example, client 106 may perform the actions of blocks 504-510, and server 102 may perform the action(s) of block 502.

As described above with reference to blocks 418 and 406, the server has already transmitted the higher-relevancy TV metadata burst via a unicast communication, and the client has already received the higher-relevancy TV metadata via the unicast burst. Although specific implementations may vary, in typical general scenarios, the server responds once with a higher-relevancy TV metadata burst for each unicast request that is received from a client.

At block 502, the server transmits a TV metadata stream via a multicast communication. For example, server 102 may transmit TV metadata 110 to multiple clients 106 via a streamed multicast communication 116(M) over network 104. The TV metadata multicast stream may be formulated as a repeating carousel in which the entirety of the TV metadata, or at least a portion thereof, is repeated every interval of a given predetermined length. The length of the repeating interval depends on the amount of TV metadata and the bandwidth allocated to the repeating carousel.

At block 504, the client receives the TV metadata multicast stream. For example, client 106 may receive TV metadata 110 in a streamed multicast communication 116(M) via network 104. With respect to an EPG data 204 type of TV metadata 110, the TV metadata multicast stream may be an EPG data stream 204(DS).

At block 506, the different versions of the TV metadata as received in the unicast burst and the multicast stream are harmonized. For example, each of TV metadata 110 as received via unicast communication 116(U) and TV metadata 110 as received via multicast communication 116(M) may include respective version numbers. If the version number of the TV metadata unicast burst matches the version number of the TV metadata multicast stream, there is no need to process the same information twice.

At block 508, the newly-received TV metadata is processed. For example, TV metadata 110 as received via multicast communication 116(M) that is not duplicative of that received via unicast communication 116(U), may be processed. TV metadata 110 may be processed to enable client 106 to tune to a given television channel, to provide special services to a subscriber, to present the EPG in a UI to the subscriber, some combination thereof, and so forth.

At block 510, the processed versions are blended. For example, the processed TV metadata 110 as received via unicast communication 116(U) (which is processed with the action(s) of block 408) and the processed TV metadata 110 as received via multicast communication 116(M) (which is processed with the action(s) of block 508) may be blended to form one homogenous unit of TV metadata. Eventually, TV metadata 110 as received via unicast communication 116(U) is aged out of the homogeneous unit of TV metadata because it is gradually being replaced with more-current TV metadata 110 that is received in the repeating carousel via multicast communication 116(M).

### Example Device Implementations for Hybrid Unicast and Multicast Data Delivery

FIG. 6 is a block diagram of an example device 602 that may be employed in conjunction with hybrid unicast and multicast data delivery. For example, a device 602 may be a client 106 or a server 102 (of FIG. 1). In certain implementations, devices 602 are capable of communicating across one or more networks 614, such as network 104. As illustrated, two devices 602(1) and 602(d) are capable of engaging in communication exchanges via network 614. Example relevant communication exchanges include transmissions of TV metadata 110 in multicast communications 116(M) and/or unicast communications 116(U).

More generally, device 602 may represent a server or a client device; a storage device; a workstation or other general computer device; a set-top box or other television device; a personal digital assistant (PDA), mobile telephone, or other mobile appliance; some combination thereof; and so forth. As illustrated, device 602 includes one or more input/output (I/O) interfaces 604, at least one processor 606, and one or more media 608. Media 608 includes processor-executable instructions 610. Although not specifically illustrated, device 602 may also include other components.

In a described implementation of device 602, I/O interfaces 604 may include (i) a network interface for communicating across network(s) 614, (ii) a display device interface for displaying information such as a UI on a display screen, (iii) one or more man-machine device interfaces, and so forth. Examples of (i) network interfaces include a network card, a modem, one or more ports, and so forth. Examples of (ii) display device interfaces include a graphics driver, a graphics card, a hardware or software driver for a screen/television or printer, etc. to create a UI and/or to display television information 108. Examples of (iii) man-machine device interfaces include those that communicate by wire or wirelessly to man-machine interface devices 612 (e.g., a keyboard or keypad, a mouse or other graphical pointing device, a remote control, etc.) to manipulate and interact with a UI created by device 602.

Generally, processor 606 is capable of executing, performing, and/or otherwise effectuating processor-executable instructions, such as processor-executable instructions 610. Media 608 is comprised of one or more processor-accessible media. In other words, media 608 may include processor-executable instructions 610 that are executable by processor 606 to effectuate the performance of functions by device 602.

Thus, realizations for hybrid unicast and multicast data delivery may be described in the general context of processor-executable instructions. Generally, processor-executable instructions include routines, programs, applications, coding, modules, protocols, objects, interfaces, components, metadata and definitions thereof, data structures, application programming interfaces (APIs), etc. that perform and/or enable particular tasks and/or implement particular abstract data types. Processor-executable instructions may be located in separate storage media, executed by different processors, and/or propagated over or extant on various transmission media.

Processor(s) 606 may be implemented using any applicable processing-capable technology. Media 608 may be any available media that is included as part of and/or accessible by device 602. It includes volatile and non-volatile media, removable and non-removable media, and storage and transmission media (e.g., wireless or wired communication channels). For example, media 608 may include an array of disks for longer-term mass storage of processor-executable instructions, random access memory (RAM) for shorter-term storage of instructions that are currently being executed, flash memory for medium to longer term and/or portable storage, optical disks for portable storage, and/or link(s) on network 614 for transmitting television information 108 and/or other communications, some combination thereof, and so forth.

As specifically illustrated, media 608 comprises at least processor-executable instructions 610. Generally, processor-executable instructions 610, when executed by processor 606, enable device 602 to perform the various functions described herein. Processor-executable instructions 610 may include, for example, a client TV metadata module 114, TV metadata 110, a television metadata segmenter 308, and/or a television metadata disseminator 310, and so forth.

An example hybrid notification implementation is described here by way of example but not limitation. This example hybrid notification implementation is based on a client/server model. The server is responsible for managing data preparation for a population of client devices (e.g., set-top box (STB) devices). The hybrid notification system manages multiple classes of data (e.g., EPG, SI, SMS, etc.).

The server includes factored data processing modules that continuously create data to be delivered to clients. The server is organized into data source modules (e.g., blocks 202, 204, 302, 304, and 306 of FIG. 3) that coordinate with notification modules (e.g., blocks 308 and 310 of FIG. 3). The notification modules receive prepared data structures from the data source modules. The notification modules manage the data delivery to client devices.

Data messages intended for multiple devices are delivered via multicast, and they are qualified by header (e.g., version) information that provides sufficient processing context for clients. An example of a data message for multicast would be a repeating carousel of TV metadata and its associated version information. Clients receive the version information, and they can compare it with the version of any other TV metadata that has been previously handled. This can avoid redundant processing.

Generally, the client receives TV metadata from the server, with the TV metadata including version information. In a cold-boot, or start-up scenario, the client uses version state information to determine what transactions it needs in order to become functional. In the hybrid notification scenario, a client can quickly determine that it can utilize a burst of information to start more quickly. The client then initiates a unicast request for such a burst of information. The request results in a unicast burst response from the server, with the unicast burst response being tailored specifically for that client.

For example, a client may boot up at 8:10 AM and request guide data for the next two hours (or four hours, six hours, etc.). Upon receipt of this two-hour burst of TV metadata in a unicast communication, the client can become operational and show, e.g., title and description information about the TV media data that is being displayed or is displayable over the next two hours. Over time, the client receives multicast metadata to progressively enhance its data cache (e.g., in 12-hour blocks).

This example hybrid notification implementation is efficient because it allows longer intervals for the multicast-based, repeating carousel transmissions (e.g., with a repetition interval of 10 minutes) while simultaneously enabling client devices to become functional without having to wait for receipt of any specific TV metadata from the repeating carousel (e.g., the average wait time is five minutes with a ten-minute repetition interval).

In this example hybrid notification implementation, the server has an ability to segment data delivery into burst-capable and multicast-appropriate portions at the server. The server can continuously analyze data over time so as to prepare for the hybrid data delivery scenarios (e.g., cold-boot power-on, reboot, etc. of an STB device).

The client devices have an ability to manage hybrid delivery in which an initial unicast burst is sufficient for the client device to become operational upon receipt of the unicast burst (e.g., prior to receiving any TV metadata from the multicast transmission). This can reduce the time delay or latency between the starting/initialization state and the operational state of the client device. The client devices also have an ability to gradually improve levels of television functionality over time, as more multicast TV metadata arrives. The client devices blend the multicast TV metadata structures with the TV metadata from the initial unicast burst. Thus, the performance of, and/or the features provided by, an initiating client device can progressively improve over time by gradually using more and more of the shared TV metadata structures received via the multicast stream.

The devices, actions, aspects, features, functions, procedures, modules, data structures, schemes, approaches, architectures, components, etc. of FIGS. 1-6 are illustrated in diagrams that are divided into multiple blocks. However, the order, interconnections, interrelationships, layout, etc. in which FIGS. 1-6 are described and/or shown are not intended to be construed as a limitation, and any number of the blocks can be modified, combined, rearranged, augmented, omitted, etc. in any manner to implement one or more systems, methods, devices, procedures, media, apparatuses, APIs, arrangements, etc. for hybrid unicast and multicast data delivery.

Although systems, media, devices, methods, procedures, apparatuses, techniques, schemes, approaches, arrangements, and other implementations have been described in language specific to structural, logical, algorithmic, and functional features and/or diagrams, it is to be understood that the invention defined in the appended claims is not necessarily limited to the specific features or acts described above. Rather, the specific features and acts described above are disclosed as example forms of implementing the claims.

What is claimed is:

1. A client device configured to perform actions comprising:
transmitting a request for higher-relevancy television metadata;
receiving the higher-relevancy television metadata via a unicast burst; and
receiving television metadata via a multicast stream;
wherein the multicast stream comprises a repeating carousel of television metadata.

2. The client device as recited in claim 1, wherein the higher-relevancy television metadata includes service information about multiple television channels.

3. The client device as recited in claim 1, wherein the higher-relevancy television metadata includes electronic program guide (EPG) data for a predetermined higher-relevancy period.

4. The client device as recited in claim 1, wherein the client device is configured to perform further actions comprising:
processing the higher-relevancy television metadata; and
responsive to one or more user instructions, utilizing at least a portion of the processed higher-relevancy television metadata.

5. The client device as recited in claim 4, wherein the portion of processed higher-relevancy television metadata that is utilized is utilized prior to when television metadata having a matching version is received as part of the repeating carousel of television metadata in the multicast stream.

6. The client device as recited in claim 1, wherein the client device is configured to perform a further action comprising:
blending the higher-relevancy television metadata with the repeating carousel of television metadata as it is received via the multicast stream.

7. The client device as recited in claim 6, wherein the client device is configured to perform a further action comprising:
gradually providing more television functionality to a user of the client device as the blending action is performed.

8. A method for a server, the method comprising:
receiving from a client device a request for higher-relevancy television metadata;
determining a higher-relevancy television metadata burst;
transmitting the higher-relevancy television metadata burst to the client device via a unicast communication responsive to the receiving; and
transmitting a television metadata stream to the client device via a multicast communication.

9. The method as recited in claim 8, wherein the request includes a higher-relevancy television metadata period; and wherein the determining comprises determining the higher-relevancy television metadata burst based on the higher-relevancy television metadata period.

10. The method as recited in claim 8, wherein the higher-relevancy television metadata burst comprises service information including multiple respective network location and bit rate pairs for multiple respective television channels.

11. The method as recited in claim 8, wherein the higher-relevancy television metadata burst comprises electronic program guide (EPG) data corresponding to a higher-relevancy EPG period.

12. The method as recited in claim 8, wherein the determining comprises repeatedly determining the higher-relevancy television metadata burst based on a predetermined higher-relevancy television metadata period as time transpires.

13. The method as recited in claim 12, wherein the determining is repeated at intervals corresponding to a minimum temporal granularity of an electronic program guide (EPG).

14. The method as recited in claim 8, wherein:
the transmitting the higher-relevancy television metadata burst to the client device via a unicast communication responsive to the receiving comprises transmitting the higher-relevancy television metadata burst to the client device via the unicast communication using a first communication channel; and
the transmitting a television metadata stream to the client device via a multicast communication comprises transmitting the television metadata stream to the client device via the multicast communication using a second, different communication channel.

15. A server device comprising:
media having electronic program guide (EPG) data;
a television metadata segmenter that segments the EPG data into at least a higher-relevancy EPG period to extract higher-relevancy EPG data corresponding to the higher-relevancy EPG period; and
a television metadata disseminator that transmits respective higher-relevancy EPG data bursts via respective unicast communications to respective ones of multiple clients and that transmits an EPG data stream to the multiple clients via a multicast communication.

16. The server device as recited in claim 15, wherein the server device comprises at least part of a head-end of a television system.

17. The server device as recited in claim 15, wherein the respective unicast communications are transmitted to the respective ones of the multiple clients responsive to receiving multiple respective requests for higher-relevancy EPG data from the respective ones of the multiple clients.

18. The server device as recited in claim 15, wherein the EPG data stream transmitted to the multiple clients via the multicast communication comprises a repeating carousel of EPG data.

19. The server device as recited in claim 18, wherein each of the higher-relevancy EPG data bursts comprises a portion of the EPG data starting from a present time and extending to an end of the higher-relevancy EPG period.

20. The server device as recited in claim 15, wherein:
the media has service information (SI) for multiple television channels; and
the television metadata disseminator transmits the SI to the respective ones of the multiple clients via the respective unicast communications.
